(19) United States
(12) Patent Application Publication
(10) Pub. No.: US 2007/0044613 A1
(43) Pub. Date: Mar. 1, 2007

(54) Rotary cutting device

(76) Inventor: Robert Cohn, Omaha, NE (US)

Correspondence Address: GILBRETH ROEBUCK BYNUM DERRINGTON SCHMIDT WALKER;& TRAN, LLP, FROST BANK BUILDING, 6750 WEST LOOP SOUTH, SUITE 920, BELLAIRE, TX, 77401, US

(21) Appl. No.: 11/216,571

(22) Filed: Sep. 1, 2005

(51) Int. Cl. B26D 1/56

(52) U.S. Cl. 83/342; 83/343

(57) ABSTRACT

The present invention is an improved rotary cutting device for continuously cutting a web of material, such as paper, cardboard, plastic sheet, steel sheet, aluminum foil, etc. In particular, the present invention relates to a rotary cutter assembly for continuously cutting a web of material to predetermined lengths with cut lines that are essentially perpendicular to the feed direction of the web. A knife rotor is provided with its axis of rotation being perpendicular to the feed direction of the web to be cut. A straight knife is embedded in a straight slot on the knife rotor with a straight blade protruding radially from the surface of the rotor. The blade is positioned at an angle to the axis of rotation of the knife rotor. A stationary round bar is provided next to the knife rotor and cooperates with the knife rotor to cut the web passed therebetween. The stationary round bar is also angled relative to the longitudinal axis of the knife rotor, but in the opposite direction relative to the blade, so that an arc subscribed by any given point of the blade throughout the length of the blade is tangent to the external circumferential surface of the stationary round bar. During operation, a shear cut can be made to the continuous web passed between the knife rotor and the stationary round bar, producing a straight cut line perpendicular to the feed direction of the web.

### FIELD OF THE INVENTION

The present invention relates to a rotary cutter assembly for continuously cutting a web of material to predetermined lengths. In particular, the present invention relates to a rotary cutter assembly for continuously cutting a web of material to predetermined lengths with cut lines that are essentially perpendicular to the feed direction of the web.

### BACKGROUND OF THE INVENTION

In order to continuously cut a web of material, such as paper, cardboard, plastic sheet, steel sheet, aluminum foil, etc., conventionally rotary cutters have been used. The principle of operation of these cutters is that a pair of knife drums, each equipped with a knife extending in the longitudinal direction of an external circumferential surface thereof, rotate in parallel with each other at a close spacing so that a lengthy sheet of material unwound from a feed roll device can be cut by intercrossing action of the knives, as though operating a pair of scissors.

Depending on the orientational relationship between the knife and the longitudinal axis of the drum, the drum-based rotary cutters can be categorized into two groups, parallel cut drums and helical cut drums.

The parallel cut types have straight knives mounted parallel to the longitudinal axis of the drum. The parallel cut type drums are limited to the softer, lighter gauges due to the high force requirements necessary to make a simultaneous shear cut across the entire width of the material. The parallel cut rotary drum shears can provide good quality cutting at high speeds within these limitations, producing a straight cut line that can be perpendicular to the direction of the material flow.

The helical cut drum shears are generally not used for cut-to-length operations due to the difficulties in making a straight cut of a certain angle, particularly 90°, to the feed direction of web, but they also offer some advantages over the parallel cut types. With the helical cut drum shears, the knives are mounted along a helical angle on the drum. Accordingly, only a relatively small portion of the knife is shearing the material at one time as the drum rotates, resulting in significantly less force than typical parallel cut rotary drum shears. For example, a helical cut rotary drum having knives at a 5 degree helix angle may require only 10% of the cutting force required for a parallel cut, while this could reduce the equipment cost and provide significant savings for shearing applications, problems associated with the helical type drum shears make them generally unsuitable for cut-to-length operations. One such problem is that the knife cuts along a helix angle as the drums rotate, which creates an angled cut on the material. Cut-to-length operations typically require a squared cut perpendicular to the feed direction of the strip. Accordingly the helical cutting drum shear is typically limited to applications where angle of the cut is not important.

A few improvements to the helical cut drums have been devised to at least partially overcome the problems associated with the helical drum drums.

A common motif in a first series of improvements has been the placement of the drum sets in a non-perpendicularly manner to the direction of the material flow to compensate for the relationship of the helical cutting blades with respect to the continuous web, resulting in a straight transverse cut across the web. U.S. Pat. No. 5,720,210 teaches a rotary cutter wherein the knives, spirally disposed on a knife rotor, cooperate with spirally disposed circumferential surface members on a plane rotor, to cut a paper or cardboard. The knife rotor and plane rotor are obliquely aligned to the direction of feeding of the roller paper, resulting in a cut line substantially orthogonal to the paper feeding direction. U.S. Pat. Nos. 6,742,427 and 6,389,941, teach the use of a pair of rotary cutting drums equipped with matching spiral knives. The drum set, while positioned obliquely to the feed direction of the paper, can result in a cut line perpendicular to the feed direction of the paper.

Another method of improvement is the subject of the invention in U.S. Pat. No. 3,956,954, which teaches the use of a pair of straight cutting blades affixed to the shaft at an angle to the axis of the shaft to provide a V-cutting edge. The V-shaped configuration provides two contact points between the blades and the complementary cutting member during the actual cutting operation and insures a rapid accurate shear cut. The angle between the two blades is close to 180° and therefore a cut that is substantially perpendicular to the feed direction of paper can be obtained.

Accordingly, it is an object of the present invention to provide a simple rotary cutting assembly capable of shear cutting a continuous web of material at a specific angle to the feed direction of the material.

It is another object of the present invention to provide a simple rotary cutting assembly capable of shear cutting a continuous web of material and producing a cut line perpendicular to the feed direction of the material.

It is a further object of the present invention to provide a simple rotary cutting assembly possessing an open structure that can be easily cleaned and sanitized.

It is yet another object of the present invention to provide a method for cutting a continuous web using the simple rotary cutting assembly of the present invention, wherein the rotary cutting assembly can be conveniently cleaned and sanitized when necessary.

### SUMMARY OF THE INVENTION

The present invention is an improved rotary cutting device for continuously cutting a web of material, such as paper, cardboard, plastic sheet, steel sheet, aluminum foil, etc. In particular, the present invention relates to a rotary cutter assembly for continuously cutting a web of such material to predetermined lengths with cut lines that are essentially perpendicular to the direction of the web flow.

A knife rotor is provided and the rotor is positioned with its axis of rotation (i.e., longitudinal axis) being perpendicular to the feed direction of the web to be cut. A straight knife is embedded in a straight slot on the knife rotor with a straight blade protruding radially from the surface of the rotor. The knife is so positioned on the rotor that the cross-sectional plane of the knife rotor, which intersects the longitudinal axis of the knife rotor at the middle point of the axis, divides the knife into to two geometric halves of equal length. The knife/blade is at a first angle relative to the longitudinal axis of the knife rotor. Due to the angled position of the straight knife, the further away a given point on the blade is from the middle point of the blade, the larger the arc is which is subscribed by such a given point during the revolution of the rotor. A stationary round bar is provided next to the knife rotor and cooperates with the knife rotor to cut the web passed therebetween. The stationary round bar is so positioned that the arc subscribed by the middle point of the blade during a revolution of the rotor is tangent to the stationary round bar at half way of the bar's length. The stationary round bar is also angled relative to the longitudinal axis of the knife rotor, but in the opposite direction relative to the blade, so that an arc subscribed by any given point of the blade throughout the length of the blade is tangent to the external circumferential surface of the stationary round bar. As a result, a shear cut can be made to the continuous web passed between the knife rotor and the stationary round bar, producing a straight cut line perpendicular to the feed direction of the web.

Other objects, features and advantages of the present invention are described in greater detail below in conjunction with the drawings.

### BRIEF DESCRIPTION OF THE DRAWINGS

The invention and developments thereof are described in more detail in the following by way of embodiments with reference to the drawings, in which:

FIG. 1 is a perspective view of the cutting apparatus of the present invention.

FIG. 2 is a front view of the apparatus illustrated in FIG. 1.

FIG. 3 is a cross-sectional view taken along section line 3-3 of FIG. 2 illustrating the relative orientations of the blade and the stationary round bar.

FIGS. 4a and 4b are top views of the blade and stationary round bar relative to the longitudinal axis of the knife rotor as illustrated in FIG. 3.

FIG. 5 is a cross-sectional view of the knife rotor and blade assembly taken along section line 5-5 of FIG. 3.

FIGS. 6a, 6b, and 6c are simplified cross-sectional views taken along section lines 6a-6a, 6b-6b, and 6c-6c, respectively, of FIG. 3 illustrating the relative positions of different points on the blade and the stationary round bar when the blade is tangent to the external surface of the stationary round bar both at their middle points.

FIG. 7 is superposition of simplified cross-sectional views taken along section lines 6b-6b and 6c-6c, illustrating the amount of displacement of the stationary round bar from its middle point to its distal end.

### DETAILED DESCRIPTION OF THE INVENTION

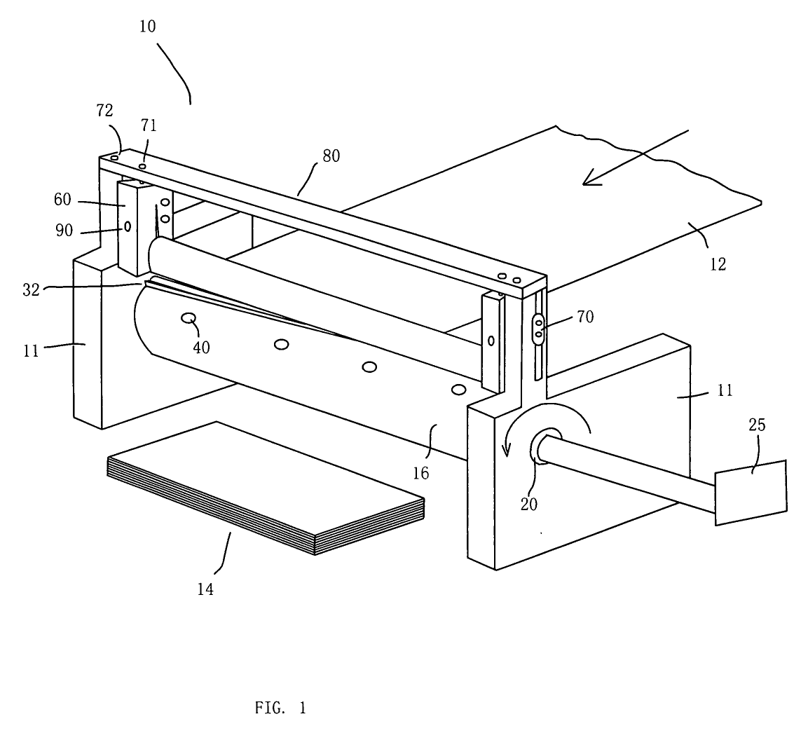

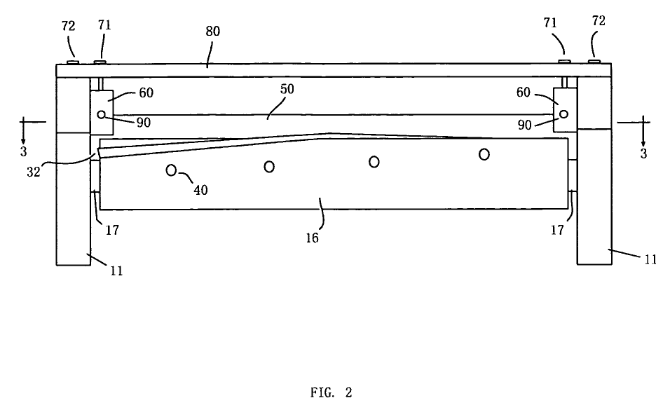

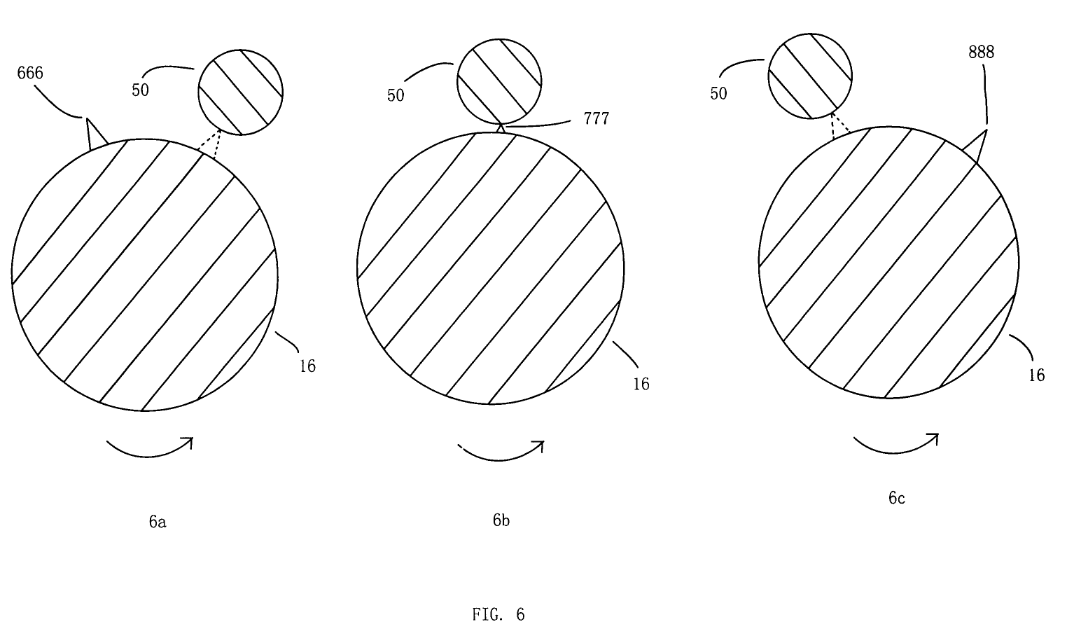

Referring to FIGS. 1 and 2, there is illustrated a rotary cutter 10 that is capable of accurately cutting sheets 14 of a predetermined size from a continuously moving web 12. The cut line is a straight line and the angle between the cut line and the direction of the web flow can be adjusted to any desired value. In particular, sheets with cut lines that are perpendicular to the feed direction of the web can be produced. A knife rotor is provided with its longitudinal axis being perpendicular to the direction of the web flow. The main body 16 of the rotor is enclosed by two metal plates 11. The rotor has two end shaft pieces 17 with a smaller radius and coaxial with the cylinder of the main body, to which the two metal plates 11 are attached, allowing the knife rotor to freely rotate in the space enclosed by the two plates while eliminating longitudinal movement. Engaging means 20 is provided on at least one end of the knife rotor so that the rotor can be coupled to and driven by a motor (not shown). Such engaging means can be in the form of any known structures such as direct motor coupling, or a series of gears, timing pulleys and belts. A straight slot 30 (shown in FIG. 6) is provided on the exterior peripheral surface of the knife rotor and a knife 32 with a straight blade is fixed in the slot by a plurality of bolts lodged in openings/holes 40. A stationary round bar 50 is located next to the knife rotor. The blade protruding from the circumference of the knife rotor engages with the outer surface of the stationary round bar to cut the web passed therebetween. The stationary round bar is fixed in its position by being fixed, via the bolt and nut assemblies 90, relative to two head pieces 60, which in turn are fixed to the metal plates 11 via bolt and nut assemblies 70. New and unworn cutting surface can be conveniently exposed by rotating the stationary round bar after temporarily loosening the bolt and nut assembly 90. A slender metal strip 80 is provided, along the longitudinal axis of the knife rotor and on top of the head pieces. Fixing means, such as bolts and nuts, 71 and 72 are employed to fix the metal strip to both of the head pieces and both metal plates, thereby eliminating undesired relative motions between the components and holding the assembly as a unitary structure. A counterclockwise rotation is indicated for the knife rotor to match the feed direction as shown.

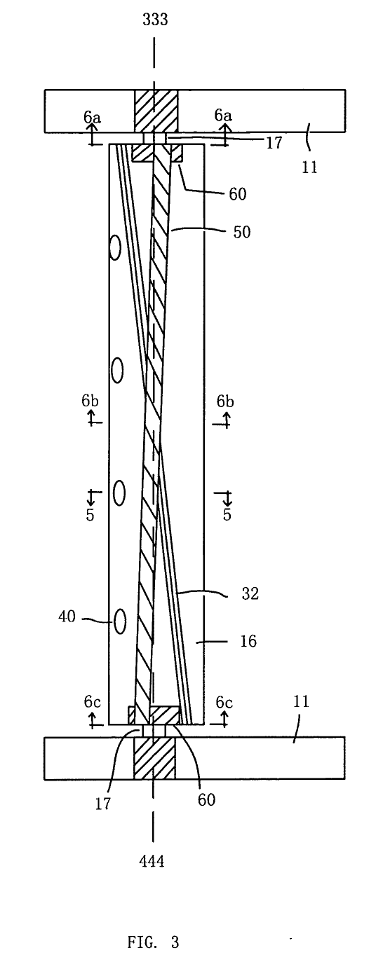

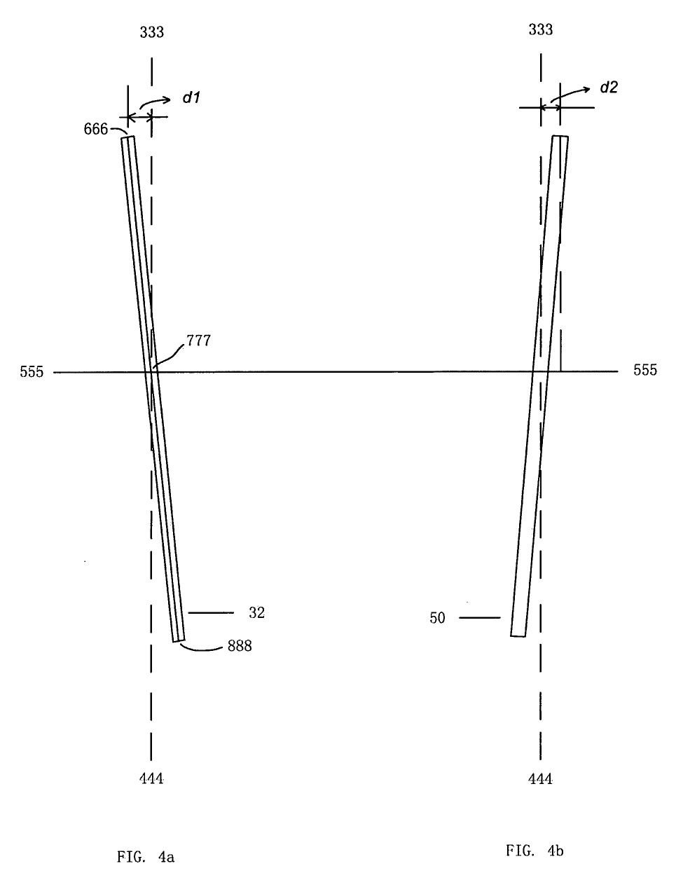

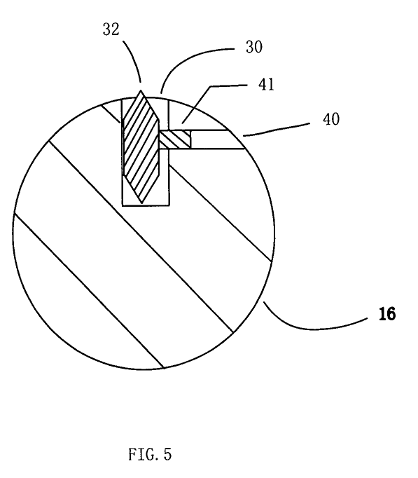

FIG. 3. provides a cross-sectional view of the assembly viewed from the top taken along the section line 3-3 of FIG. 2. It can be appreciated from this perspective and FIGS. 4a and 4b that the knife and the stationary round bar, instead of running parallel to the longitudinal axis of the knife rotor (line 333-444, i.e., the axis of rotation), are offset in the opposite directions relative to the longitudinal axis of the knife rotor, by rotating in the plane of view in FIGS. 3, 4a, and 4b, about an axis which intersects the blades and the stationary round bar at their middle points respectively and which is also perpendicular to the plane of the view (through point 777). The plane which is perpendicular to the axis of rotation of the knife rotor and intersects the axis at the middle point of the axis, represented by the line 555-555 by which it intersects the plane of the page, also intersects the blade and the stationary round bar at their middle points. The two distal ends of the blade are distinguished (point 666 and point 888) in FIG. 4a to enable the discussion of cutting sequence shown in FIG. 5. Each of the two distal ends of the blade is displaced by a distance d1 as shown in FIG. 4a. Each of the two distal ends of the stationary round bar is displaced by a distance of d2 as shown in FIG. 4b.

FIG. 5, a partial cross-sectional view taken along the cut line 5-5 in FIG. 3, illustrates the structure of the knife rotor, the embedded blade and fixing means. A straight slot 30 is provided across the entire length of the rotor for accommodating the knife. The knife, while can be of any conventional shape, such as the hexagonal shape depicted in FIG. 5, exposes a blade 32 on the external circumferential surface of the rotor. A series of openings/holes 40 are provided in the rotor intersecting the slot. The inner wall of the holes are at least partially threaded so that bolts 41 can be used to tightly hold the knife against the opposite side (relative to the opening) of the wall of the slot, preventing any undesirable movement of the blade during operation.

FIGS. 6a, 6b and 6c illustrate the relative positions of the stationary round bar to the blade at various positions of the blade at the moment during the operation of the cutter assembly when the middle point of the blade 777 is tangent to the stationary round bar at the bar's middle point, a scenario represented by FIGS. 1, 2 and 3. These cross-sectional views are simplified (compared to FIG. 5) to emphasize the relative positions of the blade to the stationary round bar. A counterclockwise rotation for the knife rotor is shown in FIGS. 6a, 6b and 6c. FIG. 6a is a slice of the knife rotor and stationary round bar which is taken at a first end of the blade, 666. It can be appreciated from FIG. 6a that this point of the blade 666 has passed its engagement/cutting point with the stationary round bar, which is shown in dotted lines. Therefore, a cut has been made to the web by 666 prior to the moment embodied by the solid lines of the blade. FIG. 6b is a slice of the knife rotor and stationary round bar which is at the middle point of the blade 777 and correspondingly by design, the middle point of the stationary round bar. The point of the blade at its middle point, 777, is tangent to the stationary round bar and is actively engaged in the cutting operation. In fact, 777 is the only point engaged in the cutting operation at this instant. FIG. 6c is a slice of the knife rotor and stationary round bar which is taken at a second end of the blade, 888. As shown in the figure, 888 is yet to engage with the stationary round bar and therefore will only cut the web at this end of the blade when 888 meets the stationary round bar at a later time, as shown in dotted lines.

As exemplified by the snapshot of the assembly during operation shown in FIGS. 6a, 6b and 6c, the blade, when engaged in active cutting operation with the stationary round bar, is always in contact with the stationary round bar at a single point. The point of contact propagates from 666 to 888 during a counterclockwise revolution of the knife rotor, resulting in a shear cut.

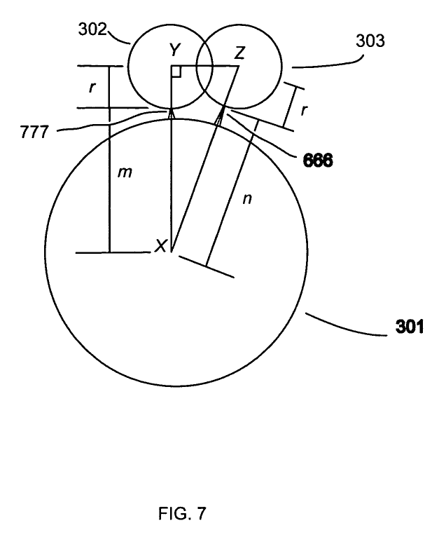

FIG. 7 illustrates the amount of displacement required for the stationary round bar from its middle point to its distal end in order to achieve a straight cut perpendicular to the feed direction of web. FIG. 7 is the superposition of the cross-sectional views of the knife rotor and stationary round bar taken along the lines 6b-6b and 6c-6c in FIG. 3. The view presented in FIG. 7 is simplified, as compared to FIG. 5, to focus on the relative position of the stationary round bar and the knife rotor. The circle 301 represents the knife rotor. The circle 302 represents the stationary round bar when the middle point of the stationary round bar is in contact with the middle point of the blade 777 (FIG. 6b). The circle 303 represents the stationary round bar when the outermost point of the blade 666 is in contact with the stationary round bar (FIG. 6a, dotted). Strictly speaking, 302 and 303 should be shown as ovals due to the angled placement of the stationary round bar. However, circles are reasonable approximation for the small angles typically employed (e.g. 1 degree for a 10-inche long blade) and the approximation reduces the complexity of calculations. The distance between the centers of the circle 301, point X, to the middle point of the blade, point 777, is m inches. The distance between the center of the circle 301, point X, and the outermost point of the blade, point 666, is n inches. The radius of the circles 302 and 303 is r inches. The angle between line XY and line YZ is 90°. Therefore, according to simple trigonometry, the distance between the centers of the circles 302 and 303, points Y and Z respectively, i.e., the distance d2 in FIG. 4b, can be calculated using the following equation:
YZ≡d2=[(n+r)²−(m+r)²]^{1/2} (equation A)

Hence, each distal end of the stationary round bar should be displaced by amount equal to YZ (d2) in order to ensure that a straight cut line perpendicular to the direction of the web flow is generated via a shear cut which is propagated from the point 666 to point 888 during a counterclockwise revolution of the knife rotor.

As is obvious to an artisan skilled in the art and familiarized with the teaching of the invention, a cut line at an angle other than 90° relative to the feed direction of the web, if desired, can be achieved by displacing the blade and/or the stationary round bar at a different amount as disclosed above and varying the relative speed of rotary knife to speed of the web.

The rotating knife circumferential speed can operate at any speed equal to or greater than the web speed to cut any length sheet desired, longer or shorter than the circumference of that subscribed by the rotary knife.

A preferred example is provided as following for the cutting of a continuous web of paper into letter sized stock. It is obvious that the dimensions of the parts, the amount of displacements of the blade and stationary bar and other parameters can be modified according to the requirements for a specific application.

The displacement of the blade (d1 in FIG. 4a) is 0.500 inches. The knife rotor possesses a radius of 0.9375 inches and a length of 10.125 inches for its main body. The stationary round bar possesses a radius of 0.375 inches. The middle point of the blade 777 subscribes an arc with a radius of 1.03078 inches. The distal points of the blade, 666 and 888 subscribe an arc with a radius (i.e., distance between the points and) of 1.11803 inches. Using equation A, it can be determined that the desired displacement of the stationary round bar (d2) is 0.58182 inches.

The rotary cutter can be manufactured using any conventional material, such as steel, stainless steel, etc. The choice of preferred material is dictated by a variety of factors, including the cost and type of applications. For example, stainless steel is preferred when the cutter is to be used for cutting plastic or paper sheets for use in the food packaging industry. The open and simple structure of the rotary cutter in the present invention allows for convenient cleaning and sanitizing between two consecutive runs or whenever it is needed.

As stated, a variety of materials, configurations, and applications can be employed in the practice of this invention. It is to be understood that such variations are intended to fall within the scope of the claimed invention and that the subject invention is not to be limited by the specific apparatus or method of operation described and/or depicted by the drawings nor is the invention to be limited by the specific materials and mechanical components identified and described herein. These have been designated merely to provide a demonstration of operability and selection of mechanically equivalent arrangements is not deemed a departure from the spirit of the invention being limited solely by the scope of the attached claims.

1. A rotary cutter for cutting a continuous web, which comprises:
a frame member,
a rotatable round knife rotor having a straight cutting blade affixed thereon, for rotation with said knife rotor, said rotatable round knife rotor possessing a first longitudinal axis,
a stationary round bar possessing a second longitudinal axis and mounted in said frame for contact with said cutting blade to cut said web positioned between said stationary round bar and said cutting blade,
a motor having a motor shaft coupled to said knife rotor for rotating said blade,
wherein the middle point of said cutting blade is on a plane which is perpendicular to said first longitudinal axis and intersects said first longitudinal axis at the middle point of said first longitudinal axis, dividing the cutting blade into two geometric halves of equal length,
wherein the middle point of said second longitudinal axis is also on said plane,
wherein said cutting blade is at a first acute angle to said first longitudinal axis and said second longitudinal axis is at a second acute angle to said first longitudinal axis, and
wherein said first acute angle and second acute angle are on opposite sides of said first longitudinal axis.

2. A rotary cutter according to claim 1 wherein said web is selected from the group consisting of paper sheet, plastic sheet, cardboard and metal sheet.

3. A method for cutting a continuous web, which comprises the steps of
a. cutting said continuous web using a rotary cutter according to claim 1, and
b. wherein as indicated after said cutting, cleaning and sanitizing said rotary cutter.
